(19) United States
(12) Patent Application Publication
(10) Pub. No.: US 2026/0288568 A1
(43) Pub. Date: Sep. 24, 2026

(54) DEVICE FAULT DIAGNOSIS METHOD AND APPARATUS, AND STORAGE MEDIUM

(71) Applicant: BOE Technology Group Co., Ltd., Beijing (CN)

(72) Inventor: Zhuohua LIU, Beijing (CN)

(21) Appl. No.: 19/477,791

(22) PCT Filed: May 20, 2024
(86) PCT No.: PCT/CN2024/094200

§ 371 Date: Oct. 23, 2025

(30) Foreign Application Priority Data
Jun. 29, 2023 (CN) 202310786437.1

(51) Int. Cl. G06F 11/07

(52) U.S. Cl. CPC G06F 11/079; G06F 11/0709

(57) ABSTRACT

A device fault diagnosis method, comprising: acquiring data for diagnosis of a target device; determining whether one or more abnormal sequences exist in the data for diagnosis; when it is determined that one or more abnormal sequences exist, on the basis of a statistical feature of each abnormal sequence, forming a feature vector of the abnormal sequence; and on the basis of the feature vector and a preset fault classification model, determining a fault type corresponding to the abnormal sequence.

### CROSS-REFERENCE TO RELATED APPLICATIONS

The present application is a U.S. National Phase Entry of International PCT Application No. PCT/CN2024/094200 having an international filing date of May 20, 2024, which claims priority to Chinese Patent Application No. 202310786437.1 filed to the CNIPA on Jun. 29, 2023 and entitled “Device Fault Diagnosis Method and Apparatus, and Storage Medium”. The above-identified applications are incorporated by reference herein in their entireties.

### TECHNICAL FIELD

The present disclosure relates to, but is not limited to, the technical field of the Internet of Things, in particular to a device fault diagnosis method, a device fault diagnosis apparatus, and a storage medium.

### BACKGROUND

A device fault determination method may include a fault tree analysis method, an event tree analysis method, and a failure mode and impact analysis method. Among them, the fault tree analysis method is to analyze logical relationship of a system, and decompose a device fault into a series of fundamental faults. The event tree analysis method is to track possible causes of each event based on analysis of system events, and to look for preventive measures. The failure mode and impact analysis method is to analyze components in the system one by one, predict a failure mode and impacts, and put forward corresponding risk control measures.

### SUMMARY

The following is a summary of subject matter described herein in detail. This summary is not intended to limit the protection scope of claims.

An embodiment of the present disclosure provides a device fault diagnosis method, including:
acquiring data to be diagnosed of a target device;
determining whether one or more abnormal sequences exist in the data to be diagnosed;
when it is determined that the one or more abnormal sequences exist, constructing a feature vector of each of the one or more abnormal sequences according to a statistical feature of each abnormal sequence; and determining a fault type corresponding to the abnormal sequence according to the feature vector and a preset fault classification model.

In an exemplary embodiment, determining whether the one or more abnormal sequences exist in the data to be diagnosed includes:
constructing a plurality of target sub-sequences according to the data to be diagnosed and a preset sliding window; and
determining whether an abnormal sequence exists in the data to be diagnosed according to a mean value, a standard deviation, a preset lower limit threshold of sliding mean, a preset upper limit threshold of sliding mean and a preset standard deviation threshold of each target sub-sequence.

In an exemplary embodiment, determining whether the abnormal sequence exists in the data to be diagnosed according to the mean value, the standard deviation, the preset lower limit threshold of sliding mean, the preset upper limit threshold of sliding mean, and the preset standard deviation threshold of each target sub-sequence includes:
performing, on each target sub-sequence arranged in chronological order, following operations:
when it is determined that the mean value of the target sub-sequence is less than the preset upper limit threshold of the sliding mean, taking the target sub-sequence as a start abnormal sequence, and sequentially determining whether a mean value of a next target sub-sequence of the start abnormal sequence is less than the preset upper limit threshold of the sliding mean until a target sub-sequence whose mean value is greater than or equal to the preset upper limit threshold of the sliding mean is determined, and taking a last target sub-sequence whose mean value is less than the preset upper limit threshold of the sliding mean as an end abnormal sequence; and constructing data corresponding to the start abnormal sequence, data corresponding to the end abnormal sequence, and data corresponding to all target sub-sequences between the start abnormal sequence and the end abnormal sequence into the abnormal sequence.

In an exemplary embodiment, determining whether the abnormal sequence exists in the data to be diagnosed according to the mean value, the standard deviation, the preset lower limit threshold of sliding mean, the preset upper limit threshold of sliding mean, and the preset standard deviation threshold of each target sub-sequence includes:
performing, on each target sub-sequence arranged in chronological order, following operations:
when it is determined that the mean value of the target sub-sequence is greater than the preset lower limit threshold of the sliding mean, taking the target sub-sequence as a start abnormal sequence, and sequentially determining whether a mean value of a next target sub-sequence of the start abnormal sequence is greater than the preset lower limit threshold of the sliding mean until a target sub-sequence whose mean value is less than or equal to the preset lower limit threshold of the sliding mean is determined, and taking a last target sub-sequence whose mean value is less than the preset lower limit threshold of the sliding mean as an end abnormal sequence; and constructing data corresponding to the start abnormal sequence, data corresponding to the end abnormal sequence, and data corresponding to all target sub-sequences between the start abnormal sequence and the end abnormal sequence into the abnormal sequence.

In an exemplary embodiment, determining whether the abnormal sequence exists in the data to be diagnosed according to the mean value, the standard deviation, the preset lower limit threshold of sliding mean, the preset upper limit threshold of sliding mean, and the preset standard deviation threshold of each target sub-sequence includes:
performing, on each target sub-sequence arranged in chronological order, following operations:
when it is determined that the standard deviation of the target sub-sequence is greater than the preset standard deviation threshold, taking the target sub-sequence as a start abnormal sequence, and sequentially determining whether a standard deviation of a next target sub-sequence of the start abnormal sequence is greater than the preset standard deviation threshold until a target sub-sequence whose standard deviation is less than or equal to the preset standard deviation threshold is determined, and taking a last target sub-sequence whose standard deviation is greater than the preset standard deviation threshold as an end abnormal sequence, and constructing data corresponding to the start abnormal sequence, data corresponding to the end abnormal sequence, and data corresponding to all target sub-sequences between the start abnormal sequence and the end abnormal sequence into the abnormal sequence.

In an exemplary embodiment, abnormal sequences with time intervals within a preset range are merged; or abnormal sequences of which time periods intersect with each other are merged.

In an exemplary embodiment, the preset fault classification model includes a plurality of classification models.

Determining the fault type corresponding to the abnormal sequence according to the feature vector and the preset fault classification model includes:
determining the fault type by a voting mechanism according to a classification result of each classification model.

In an exemplary embodiment, a similarity between each abnormal sequence and a preset template sequence is calculated according to a modified Dynamic Time Warping (DTW) algorithm, and a fault occurrence cause corresponding to the abnormal sequence according to the similarity is determined, wherein the preset template sequence is a sequence constructed according to abnormal data in which the fault occurrence cause is marked and a preset sliding window.

In an exemplary embodiment, calculating a similarity between each abnormal sequence and a preset template sequence according to the modified DTW algorithm includes:
for each abnormal sequence, when a length of the abnormal sequence is equal to a length of the preset template sequence, determining a similarity between the abnormal sequence and the preset template sequence according to a first accumulation sum; wherein the first accumulation sum is a sum of absolute values of differences between elements having same sequence numbers in the abnormal sequence and the preset template sequence;
when the length of the abnormal sequence is greater than the length of the preset template sequence, determining the similarity between the abnormal sequence and the preset template sequence according to all Aₐ−1 accumulation sums; wherein an Aₐ−1 accumulation sum is a sum of absolute values of differences between elements in the abnormal sequence and elements in the preset template sequence whose sequence numbers differ by a−1; wherein 1≤a≤N, N is a difference between the length of the abnormal sequence and the length of the preset template sequence, and a and N are both positive integers; and
when the length of the abnormal sequence is smaller than the length of the preset template sequence, determining the similarity between the abnormal sequence and the preset template sequence according to all B_{b}−1 accumulation sums; wherein a B_{b}−1 accumulation sum is a sum of absolute values of differences between elements in the abnormal sequence and elements in the preset template sequence whose sequence numbers differ by −b+1; wherein 1≤b≤M, M is a difference between the length of the abnormal sequence and the length of the preset template sequence, and b and M are both positive integers.

In an exemplary embodiment, constructing the plurality of target sub-sequences according to the data to be diagnosed and the preset sliding window includes:
for each datum in the data to be diagnosed, taking data in a preset sliding window with the datum as its head as a target sub-sequence.

In an exemplary embodiment, a preset upper limit threshold of sliding mean and a preset lower limit threshold of sliding mean and a preset standard deviation threshold are obtained as follows:
acquiring first normal data and first abnormal data of the target device;
calculating a first sequence mean and a first sequence standard deviation of each first sub-sequence, wherein the first sub-sequence is a sequence constructed according to the first normal data and the preset sliding window;
calculating a second sequence mean and a second sequence standard deviation of each second sub-sequence, wherein the second sub-sequence is a sequence constructed according to the first abnormal data and the preset sliding window;
determining the preset lower limit threshold of the sliding mean according to a largest first sequence mean and a smallest second sequence mean;
determining the preset upper limit threshold of the sliding mean according to a smallest first sequence mean and a largest second sequence mean; and
determining the preset standard deviation threshold according to a largest first sequence standard deviation and a smallest second sequence standard deviation.

In an exemplary embodiment, the preset fault classification model is obtained as follows:
labeling a fault type according to the first abnormal data;
training and verifying a preset original classification model according to the labeled first abnormal data; and
taking the trained and verified classification model as the preset fault classification model.

In an exemplary embodiment, labeling the fault type according to the first abnormal data includes:
constructing a plurality of sub-sequences according to the first abnormal data and a preset sliding window; determining a statistical feature of each sub-sequence; constructing a feature vector of each sub-sequence according to the statistical features of each sub-sequence; and labeling the feature vector of each sub-sequence with the fault type.

In an exemplary embodiment, the statistical features include mean value, standard deviation, range, coefficient of variation, autocorrelation system, kurtosis, and skewness of the abnormal sequence.

The present disclosure provides a device fault diagnosis apparatus, including a memory and a processor.
the memory is configured to store a program for device fault diagnosis; and
the processor is configured to read and execute the program for device failure diagnosis, and execute the device failure diagnosis method.

The present disclosure provides a computer-readable storage medium on which computer-executable instructions are stored, wherein the computer-executable instructions are for causing the computer to perform the device fault diagnosis method described above.

Other aspects of the present disclosure may be comprehended after the drawings and the detailed descriptions are read and understood.

### BRIEF DESCRIPTION OF DRAWINGS

Accompanying drawings are used for providing further understanding of technical solutions of the present disclosure, constitute a portion of the specification, and are used for explaining the technical solutions of the present disclosure together with embodiments of the present disclosure, but do not constitute limitations on the technical solutions of the present disclosure. Shapes and sizes of one or more components in the drawings do not reflect actual scales, but are only intended to schematically describe contents of the present disclosure.

FIG. 1 is a schematic diagram of a device fault diagnosis method according to at least one embodiment of the present disclosure.

FIG. 2 is a schematic flow diagram of steps of a method for generating a service environment according to at least one embodiment of the present disclosure.

FIG. 3 is a flowchart of a device fault diagnosis method according to at least one embodiment of the present disclosure.

FIG. 4A is a schematic diagram of an abnormal sequence of at least one embodiment.

FIG. 4B is a schematic diagram of an abnormal sequence of at least one embodiment.

FIG. 4C is a schematic diagram of an abnormal sequence of at least one embodiment.

### DETAILED DESCRIPTION

To make objectives, technical solutions, and advantages of the present disclosure clearer, the embodiments of the present disclosure will be described in detail below with reference to the accompanying drawings. Implementations may be implemented in multiple different forms. Those of ordinary skills in the art can easily understand such a fact that implementations and contents may be transformed into one or more forms without departing from the purpose and scope of the present disclosure. Therefore, the present disclosure should not be explained as being limited to the contents recorded in the following implementations only. The embodiments and features in the embodiments of the present disclosure may be randomly combined with each other if there is no conflict.

Ordinal numerals such as “first”, “second” and “third” in the present disclosure are set to avoid confusion between constituent elements, but not intended for restriction in quantity. “A plurality of” in the present disclosure means two or more in quantity.

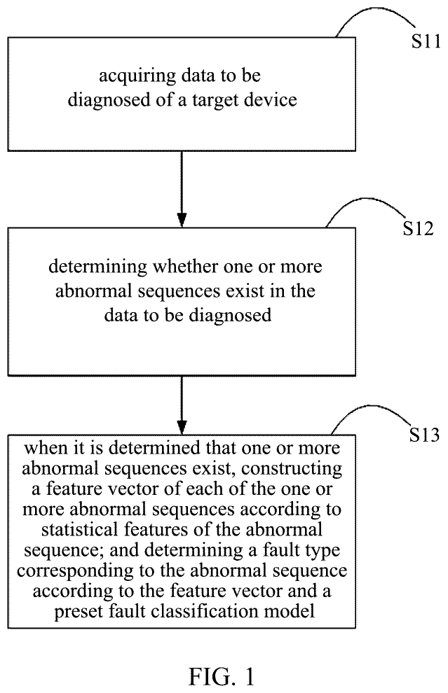

FIG. 1 is a device fault diagnosis method according to an embodiment of the present disclosure. As shown in FIG. 1, the device fault diagnosis method according to this embodiment includes steps S11 to S13:
S11: acquiring data to be diagnosed of a target device;
S12: determining whether one or more abnormal sequences exist in the data to be diagnosed; and
S13: when it is determined that one or more abnormal sequences exist, constructing a feature vector of each of the one or more abnormal sequences according to statistical features of each abnormal sequence; and determining a fault type corresponding to the abnormal sequence according to the feature vector and a preset fault classification model.

In an exemplary embodiment, a method of obtaining data to be diagnosed of a target device includes:

acquiring information to be processed from a plurality of types of information collection devices integrated in an information processing platform, the target device being the plurality of information collection devices. The plurality of types of information collection devices include devices, tablets and computers, and the information processing platform is in communication connection with the plurality of information collection devices, and the communication connection may be a TCP (Transmission Control Protocol), HTTP (Hyper Text Transfer Protocol), MQTT (Message Queuing Telemetry Transport), etc. The information collection device is configured to acquire status information of different facilities of a building, wherein the information processing platform may be an Internet of Things platform, and the information processing platform may be located on cloud or in a server in a local area network.

Among them, the plurality of types of information collection devices may be different according to different types of information to be collected. Specifically, each type of service information may correspond to an information collection device, and the information collection device may be a sensor, a computer, a camera, a tablet, a mobile phone, or the like.

Among them, the plurality of types of information collection devices may be partially or entirely located in a physical area, or may be partially located in the physical area and partially located outside the physical area as a movable information collection device. For example, when an information collection device is a sensor or a camera, the information collection device is located in the physical area to collect information on a status of a facility in the physical area, and for example, when the information collection device is a tablet, a computer, a mobile phone, or the like, the information collection device may be located outside the physical area to collect information on a deployment status of an operation for executing a target service.

For example, taking fire safety assessment as an example, and service information to be collected includes a fire hydrant system, the information collection device may include a camera for collecting an image of a fire hydrant and processing the image of the fire hydrant to obtain a status of the fire hydrant. If service information to be collected is on a fire water supply facility, it is necessary to detect integrity of the fire water supply facility, and the information collection device may be a water pressure sensor, which is configured to collect a water pressure status of the fire water supply facility.

Evidently, in some other embodiments, the information collection device may be integrated into a firefighting facility, such as a smoke alarm. The information collection device may detect the smoke alarm in real time to determine whether the smoke alarm fails or not, and send service information according to a detection result.

Taking medical safety assessment as an example, if the service information to be collected includes a ventilation system, the information collection device may include an air flow sensor for collecting air flow at various places of the ventilation system. If the service information to be collected is a working status of each disinfection apparatus in a disinfection room, the information collection device may be a sensor integrated into each disinfection apparatus for collecting status information of the disinfection apparatus.

The following describes a process of establishing a communication connection between the information processing platform (i.e., the Internet of Things platform) and the target device:

In this embodiment, how to generate a service environment on the platform to serve communication between a terminal and the Internet of Things platform is described, and the service environment may be run on a server or cloud where the Internet of Things platform is located to help the terminal access the Internet of Things platform and provide communication services required between the Internet of Things platform and the terminal. Here, in creation of the service environment, the present disclosure adopts access of a low-code device, and a developer only needs to create a first integrated instance of a first type, and then compile a data conversion script corresponding to the first integrated instance to achieve establishment of a service environment of a communication protocol.

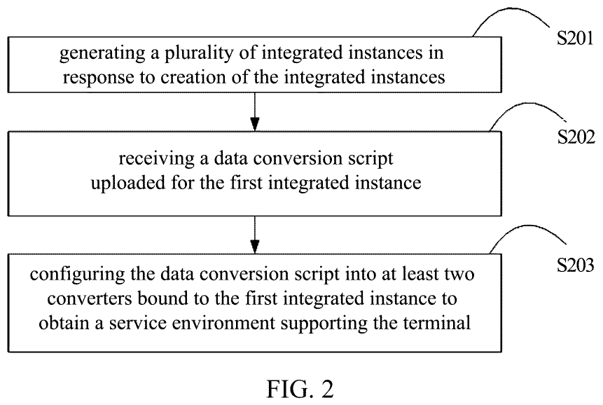

Referring to FIG. 2, which shows a step flow diagram of a method for generating a service environment of the present disclosure, the method may be performed by an electronic device to generate the service environment in the cloud, as shown in FIG. 2, and the method may specifically include the following steps:
Step S201: generating a plurality of integrated instances in response to creation of the integrated instances;

Here, the plurality of integrated instances includes a first integrated instance of a first type.

In this embodiment, the first integrated instance of the first type may refer to an integrated instance of a general communication protocol type, which, for example, includes some general protocols such as TCP, MQTT, UDP, HTTP, CoAP, etc., wherein different general communication protocols correspond to different first integrated instances, for example, the TCP protocol corresponds to a first integrated instance of the TCP type, and the MQTT protocol corresponds to a first integrated instance of the MQTT type, that is, each general communication protocol corresponds to an independent first integrated instance to provide communication services to a terminal using the general communication protocol.

The creation operation of the integrated instance may refer to an instance creation operation performed on the platform by the developer. Specifically, when the developer clicks instance creation after configuring setting parameters of the instance on a compilation interface, the developer may generate an integrated instance based on the setting parameters compiled by the developer in response to the instance creation, and run the integrated instance in response to a running operation performed by the developer after the integrated instance is generated.

Here, the setting parameters may include an instance name of the integrated instance, a type of the communication protocol, and configuration parameters related to running of the integrated instance.
Step S202: receiving a data conversion script uploaded for the first integrated instance.

Here, since the first integrated instance is aimed at the general communication protocol, in practice, in order to achieve accessing the low-code device, the developer can be allowed to compile a simple data conversion script, that is, the data conversion script can only compile a program related to data format conversion, and communication service unrelated to data conversion can be implemented by running the integrated instance, so that program development of the developer can be reduced, time can be saved, and the service environment can be quickly deployed for the device of the general communication protocol.

Here, the data conversion script may be associated with the integrated instance, and the data conversion script may be run together when the integrated instance is run.
Step S203: configuring the data conversion script as at least two converters bound to the first integrated instance to obtain a service environment supporting the terminal.

Here, the first integrated instance is configured to support communication between the terminal of the first type and the Internet of Things platform, and the converter is configured to perform conversion processing on interaction data related to the terminal of the first type in the communication.

In this embodiment, starting the data conversion script may mean mapping the data conversion script to a method that can be called by the first integrated instance, for example, the data conversion script is mapped to a golong method, and then the golang method is directly called to convert data (such as interaction data) to be converted.

Here, the data conversion script may include at least an uplink data conversion script for performing conversion processing on data that needs to be uploaded to the Internet of Things platform and a downlink data conversion script for performing conversion processing on data that the Internet of Things platform needs to send to the terminal.

In practice, the data conversion script may be started to configure it as a converter bound to the first instance, and when the data conversion script is started, the uplink data conversion script and the downlink data conversion script may be simultaneously started. The uplink data conversion script and the downlink data conversion script may be referred to as converters of the first integrated instance after being started, so that one first integrated instance includes at least two converters corresponding to the conversion of the uplink data and the conversion of the downlink data respectively.

Evidently, in some embodiments, one first integrated instance may also include two or more converters, for example, a plurality of sets of converters, wherein one set of converters includes corresponding uplink converters and downlink converters, and different sets of converters correspond to different requirements of data format conversion. This is because that, among a plurality of terminals employing a same general communication protocol, data formats required by different terminals may be different, for example, among a plurality of terminals employing the TCP protocol, data format of some terminals is text, data format of some terminals is JSON, and data format of some terminals is Binary. In this way, for the same first integrated instance, it is necessary to deal with data conversion of a plurality of data formats, whereby a set of converters may be configured for each data format to perform conversion processing on a terminal communicating using this data format.

In this way, the generated service environment can provide more improved communication services for communication between a plurality of different terminals and the Internet of Things platform, so that terminals with different protocols and different data formats can be compatible with the Internet of Things platform, thereby increasing versatility of the Internet of Things platform. For example, the terminal accesses a port opened by the first integrated instance, the first integrated instance sends data sent by the terminal to the Internet of Things platform to an uplink converter, and after the uplink converter performs conversion processing, the first integrated instance sends the converted data (that is, target data) to the Internet of Things platform. The data fed back by the Internet of Things platform to the terminal may also be received by the first integrated instance and sent to a downlink converter, and after conversion, the first integrated instance may send the data to the terminal.

In an exemplary embodiment, the data to be diagnosed may be real-time monitoring data collected and stored by the Internet of Things platform. The real-time monitoring data may be data within 3 months or data within 1 year. The real-time monitoring data is represented in a form of a sequence. Each element in the sequence represents a data point, and each data point includes at least a data value and a sampling time. The elements in the sequence are arranged in chronological order from distant to recent.

In an exemplary embodiment, determining whether the one or more abnormal sequences exist in the data to be diagnosed includes:
constructing a plurality of target sub-sequences according to the data to be diagnosed and a preset sliding window; and
determining whether an abnormal sequence exists in the data to be diagnosed according to a mean value, a standard deviation, a preset lower limit threshold of sliding mean, a preset upper limit threshold of sliding mean and a preset standard deviation threshold of each target sub-sequence.

Here, the preset lower limit threshold of the sliding mean is less than the preset upper limit threshold of the sliding mean.

In an exemplary embodiment, constructing the plurality of target sub-sequences according to the data to be diagnosed and the preset sliding window includes:

for each datum in the data to be diagnosed, taking data in a preset sliding window with the datum as its head as a target sub-sequence.

In an exemplary embodiment, the preset sliding window is represented by a time length W, W may be equal to 10T, and T is a sampling period of monitoring data of the device. W may be equal to 2T, 3T, or the like, and is not limited herein.

In an exemplary embodiment, the data to be diagnosed is, for example, X=[x1 x2 x3 x4 . . . xn], and if the preset sliding window is 3T, the constructed target sub-sequences may be X1=[x1 x2 x3], X2=[x2 x3 x4], X3=[x3 x4 x5], or the like.

Mean value of target sub-sequence X1:

$$\overline{X} 1 = \frac{{x}_{1} + {x}_{2} + {x}_{3}}{3} ,$$

Standard deviation of target sub-sequence X1: σ₁=\sqrt{(x₁−X̅1)²+(x₂−X̅1)²+(x₃−X1)²}.

In an exemplary embodiment, the preset fault classification model is obtained as follows:
acquiring first abnormal data of the target device;
labeling a fault type according to the first abnormal data; and
training and verifying a preset original classification model according to the labeled first abnormal data; and
taking the trained and verified classification model as the preset fault classification model.

In an exemplary embodiment, the first abnormal data is monitoring data during an abnormal operation period of the device.

In an exemplary embodiment, the original classification model may include random forest, decision tree, logistic regression, Support Vector Machine (SVM), neighborhood algorithm (K-Nearest Neighbor: KNN), and the like.

In an exemplary embodiment, labeling the fault type according to the first abnormal data includes:
constructing a plurality of sub-sequences according to the first abnormal data and a preset sliding window; determining a statistical feature of each sub-sequence; constructing a feature vector of each sub-sequence according to the statistical features of each sub-sequence; and labeling the feature vector of each sub-sequence with the fault type.

In an exemplary embodiment, the preset fault classification model includes a plurality of classification models.

Determining the fault type corresponding to the abnormal sequence according to the feature vector and the preset fault classification model includes:
determining the fault type by a voting mechanism according to a classification result of each classification model.

In an exemplary embodiment, the preset fault classification model includes a classification model; and
a fault type corresponding to the abnormal sequence is determined according to the feature vector and the preset fault classification model.

In an exemplary embodiment, the statistical features include mean value, standard deviation, range, coefficient of variation, autocorrelation system, kurtosis, and skewness of the abnormal sequence.

In an exemplary embodiment, determining whether the abnormal sequence exists in the data to be diagnosed according to the mean value, the standard deviation, the preset lower limit threshold of sliding mean, the preset upper limit threshold of sliding mean, and the preset standard deviation threshold of each target sub-sequence includes:
performing, on each target sub-sequence arranged in chronological order, following operations:
when it is determined that the mean value of the target sub-sequence is less than the preset upper limit threshold of the sliding mean, taking the target sub-sequence as a start abnormal sequence, and sequentially determining whether a mean value of the next target sub-sequence of the start abnormal sequence is less than the preset upper limit threshold of the sliding mean until a target sub-sequence whose mean value is greater than or equal to the preset upper limit threshold of the sliding mean is determined, and taking a last target sub-sequence whose mean value is less than the preset upper limit threshold of the sliding mean as an end abnormal sequence; and constructing data corresponding to the start abnormal sequence, data corresponding to the end abnormal sequence, and data corresponding to all target sub-sequences between the start abnormal sequence and the end abnormal sequence into an abnormal sequence.

That is, determining whether the mean value of the target sub-sequence is less than the preset upper limit threshold of the sliding mean, wherein if the mean value of the target sub-sequence is less than the preset upper limit threshold of the sliding mean, determining whether a mean value of the next target sub-sequence adjacent to the target sub-sequence is less than the preset upper limit threshold of the sliding mean, and if the mean value of the next target sub-sequence adjacent to the target sub-sequence is less than the preset upper limit threshold of the sliding mean, continuing to determine whether a mean value of a next target sub-sequence adjacent to the above-described next target sub-sequence is less than the preset upper limit threshold of the sliding mean, and by analogy, until a target sub-sequence whose mean value is greater than or equal to the preset upper limit threshold of the sliding mean is determined; and constructing data corresponding to the target sub-sequence, data corresponding to a target sub-sequence subsequent to above-described target sub-sequence whose mean value is less than the preset upper limit threshold of the sliding mean, data between the data corresponding to the target sub-sequence and data corresponding to the target sub-sequence subsequent to above-described target sub-sequence whose mean value is less than the preset upper limit threshold of the sliding mean into an abnormal sequence.

In an exemplary embodiment, determining whether the abnormal sequence exists in the data to be diagnosed according to the mean value, the standard deviation, the preset lower limit threshold of sliding mean, the preset upper limit threshold of sliding mean, and the preset standard deviation threshold of each target sub-sequence includes:
performing, on each target sub-sequence arranged in chronological order, following operations:
when it is determined that the mean value of the target sub-sequence is greater than the preset lower limit threshold of the sliding mean, taking the target sub-sequence as a start abnormal sequence, and sequentially determining whether a mean value of a next target sub-sequence of the start abnormal sequence is greater than the preset lower limit threshold of the sliding mean until a target sub-sequence whose mean value is less than or equal to the preset lower limit threshold of the sliding mean is determined, and taking a last target sub-sequence whose mean value is less than the preset lower limit threshold of the sliding mean as an end abnormal sequence; and constructing data corresponding to the start abnormal sequence, data corresponding to the end abnormal sequence, and data corresponding to all target sub-sequences between the start abnormal sequence and the end abnormal sequence into the abnormal sequence.

That is, determining whether the mean value of the target sub-sequence is greater than the preset lower limit threshold of the sliding mean, wherein if the mean value of the target sub-sequence is greater than the preset lower limit threshold of the sliding mean, determining whether a mean value of a next target sub-sequence adjacent to the target sub-sequence is greater than the preset lower limit threshold of the sliding mean, and if the mean value of the next target sub-sequence adjacent to the target sub-sequence is greater than the preset lower limit threshold of the sliding mean, continuing to determine whether a mean value of a next target sub-sequence adjacent to the above-described next target sub-sequence is greater than the preset lower limit threshold of the sliding mean, and by analogy, until a target sub-sequence whose mean value is less than or equal to the preset lower limit threshold of the sliding mean is determined; and constructing data corresponding to the target sub-sequence, data corresponding to a target sub-sequence subsequent to above-described target sub-sequence whose mean value is greater than the preset lower limit threshold of the sliding mean, data between the data corresponding to the target sub-sequence and data corresponding to the target sub-sequence subsequent to above-described target sub-sequence whose mean value is greater than the preset lower limit threshold of the sliding mean into an abnormal sequence.

In an exemplary embodiment, determining whether the abnormal sequence exists in the data to be diagnosed according to the mean value, the standard deviation, the preset lower limit threshold of sliding mean, the preset upper limit threshold of sliding mean, and the preset standard deviation threshold of each target sub-sequence includes:
performing, on each target sub-sequence arranged in chronological order, following operations:
when it is determined that the standard deviation of the target sub-sequence is greater than the preset standard deviation threshold, taking the target sub-sequence as a start abnormal sequence, and sequentially determining whether a standard deviation of a next target sub-sequence of the start abnormal sequence is greater than the preset standard deviation threshold until a target sub-sequence whose standard deviation is less than or equal to the preset standard deviation threshold is determined, and taking a last target sub-sequence whose standard deviation is greater than the preset standard deviation threshold as an end abnormal sequence, and constructing data corresponding to the start abnormal sequence, data corresponding to the end abnormal sequence, and data corresponding to all target sub-sequences between the start abnormal sequence and the end abnormal sequence into an abnormal sequence.

That is, determining whether the standard deviation of the target sub-sequence is greater than the preset standard deviation threshold, wherein if the standard deviation of the target sub-sequence is greater than the preset standard deviation threshold, determining whether a standard deviation of a next target sub-sequence adjacent to the target sub-sequence is greater than the preset standard deviation threshold, and if the standard deviation of the next target sub-sequence adjacent to the target sub-sequence is greater than the preset standard deviation threshold, continuing to determine whether a standard deviation of a next target sub-sequence adjacent to the above-described next target sub-sequence is greater than the preset standard deviation threshold, and by analogy, until a target sub-sequence whose standard deviation is less than or equal to the preset standard deviation threshold is determined; and constructing data corresponding to the target sub-sequence, and data corresponding to a target sub-sequence subsequent to above-described target sub-sequence whose standard deviation is greater than the preset standard deviation threshold, data between the data corresponding to the target sub-sequence and the data corresponding to the target sub-sequence subsequent to above-described target sub-sequence whose standard deviation is greater than the preset standard deviation threshold into an abnormal sequence.

In an exemplary embodiment, abnormal sequences with time intervals within a preset range are merged; or abnormal sequences of which time periods intersect with each other are merged.

In an exemplary embodiment, a preset upper limit threshold of sliding mean and a preset lower limit threshold of sliding mean and a preset standard deviation threshold are obtained as follows:
acquiring first normal data and first abnormal data of the target device;
calculating a first sequence mean and a first sequence standard deviation of each first sub-sequence, wherein the first sub-sequence is a sequence constructed according to first normal data and a preset sliding window;
calculating a second sequence mean and a second sequence standard deviation of each second sub-sequence, wherein the second sub-sequence is a sequence constructed according to first abnormal data and the preset sliding window;
determining a preset lower limit threshold of sliding mean according to a largest first sequence mean and a smallest second sequence mean;
determining a preset upper limit threshold of sliding mean according to a smallest first sequence mean and a largest second sequence mean; and
determining a preset standard deviation threshold according to a largest first sequence standard deviation and a smallest second sequence standard deviation.

In an exemplary embodiment, the first normal data may be monitoring data during a normal operation period of the device.

In an exemplary embodiment, the method further includes:
calculating a similarity between each abnormal sequence and a preset template sequence according to a modified Dynamic Time Warping (DTW) algorithm, and determining a fault occurrence cause corresponding to the abnormal sequence according to the similarity, wherein the preset template sequence is a sequence constructed according to abnormal data in which the fault occurrence cause is marked and a preset sliding window.

In an exemplary embodiment, a sequence with relatively obvious features may be manually selected as a preset template sequence.

In an exemplary embodiment, calculating a similarity between each abnormal sequence and a preset template sequence according to the modified DTW algorithm includes:
for each abnormal sequence, when a length of the abnormal sequence is equal to a length of the preset template sequence, determining a similarity between the abnormal sequence and the preset template sequence according to a first accumulation sum; wherein the first accumulation sum is a sum of absolute values of differences between elements having same sequence numbers in the abnormal sequence and the preset template sequence;
when the length of the abnormal sequence is greater than the length of the preset template sequence, determining the similarity between the abnormal sequence and the preset template sequence according to an A0-th accumulation sum to an A_{N-1}-th accumulation sum; wherein the A₀-th accumulation sum is the sum of the absolute values of the differences between the elements having the same sequence numbers in the abnormal sequence and the preset template sequence; the A₁-th accumulation sum is a sum of absolute values of differences between elements in the abnormal sequence and elements in the preset template sequence whose sequence numbers differ by 1; the A₂-th accumulation sum is a sum of absolute values of differences between elements in the abnormal sequence and elements in the preset template sequence whose sequence numbers differ by 2; the A_{N-1}-th accumulation sum is a sum of absolute values of differences between elements in the abnormal sequence and elements in the preset template sequence whose sequence numbers differ by N−1; N is the difference between the length of the abnormal sequence and the length of the preset template sequence, and N>0;
when the length of the abnormal sequence is less than the length of the preset template sequence, determining the similarity between the abnormal sequence and the preset template sequence according to an B₀-th accumulation sum to an B_{M-1}-th accumulation sum; wherein the B₀-th accumulation sum is the sum of the absolute values of the differences between the elements having the same sequence numbers in the abnormal sequence and the preset template sequence; the B₁-th accumulation sum is a sum of absolute values of differences between elements in the abnormal sequence and elements in the preset template sequence whose sequence numbers differ by −1; the B₂-th accumulation sum is a sum of absolute values of differences between elements in the abnormal sequence and elements in the preset template sequence whose sequence numbers differ by −2; the B_{M-1}-th accumulation sum is a sum of absolute values of differences between elements in the abnormal sequence and elements in the preset template sequence whose sequence numbers differ by −M+1; M is the difference between the length of the abnormal sequence and the length of the preset template sequence, and M>0;

In an exemplary embodiment, the method further includes:
sending fault types corresponding to all abnormal sequences of the target device to a customer.

In the device fault diagnosis method according to the embodiment of the present disclosure, a feature vector of each abnormal sequence is constructed according to a statistical feature of the abnormal sequence, and a fault type corresponding to the abnormal sequence is determined according to the feature vector and a preset fault classification model. Compared with the conventional classification method based on time series (time series is also called dynamic sequence, which refers to a numerical sequence in which index values of a certain phenomenon are arranged in chronological order. A time series consists of two component elements: the first is the time element, and the second is numerical element. Time series can be divided into period time series and time-point time series according to different temporal and numerical properties.), the device fault diagnosis method according to the embodiment of the present disclosure greatly improves a calculation efficiency, and also achieves good accuracy and recall rate in terms of classification effect.

In some other embodiments of the present disclosure, with an abnormal sequence interception scheme in which the sliding mean and the sliding standard deviation are combined, abnormal sequences can be efficiently identified, which prevents individual abnormal detection points can be avoided from affecting the analysis result.

In some other embodiments of the present disclosure, time window merging is performed by abnormal sequence merging to obtain a more accurate failure time and corresponding monitoring data sequence.

In some other embodiments of the present disclosure, the DTW algorithm is modified, the time series similarity is calculated based on the modified DTW algorithm, and only a minimum distance of the sequence is calculated while retaining the time attribute, thereby obtaining a more scientific and reasonable similarity calculation result.

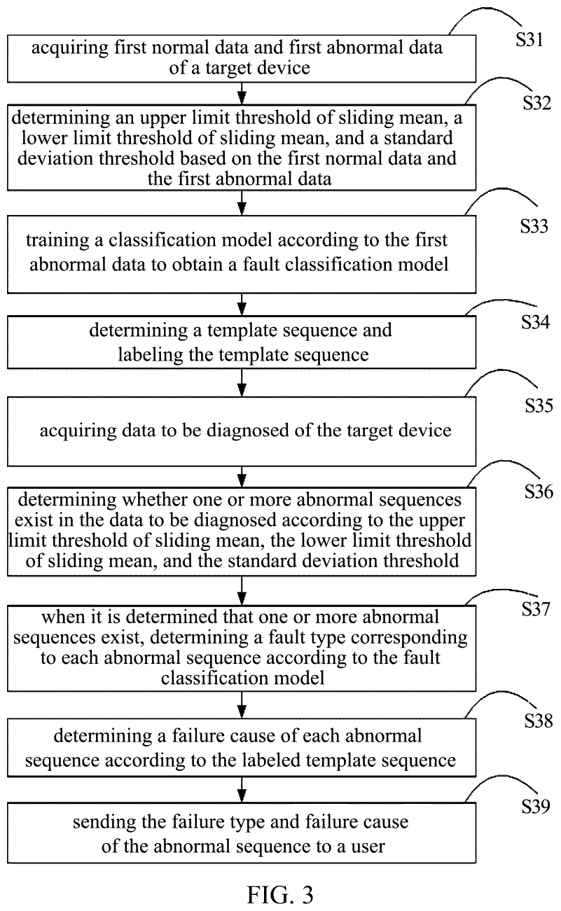

FIG. 3 is a flowchart of a device fault diagnosis method according to at least one embodiment of the present disclosure. As shown in FIG. 3, the device fault diagnosis method according to this embodiment includes steps S31 to S39:
S31: acquiring first normal data and first abnormal data of a target device;
S32: determining an upper limit threshold of sliding mean, a lower limit threshold of sliding mean, and a standard deviation threshold according to the first normal data and the first abnormal data;
S33: training a classification model according to the first abnormal data to obtain a fault classification model;
S34: determining a template sequence and labeling the template sequence;
S35: acquiring data to be diagnosed of the target device;
S36: determining whether one or more abnormal sequences exist in the data to be diagnosed according to the upper limit threshold of sliding mean, the lower limit threshold of sliding mean, and the standard deviation threshold;
S37: when it is determined that one or more abnormal sequences exist, determining a fault type corresponding to each abnormal sequence according to the fault classification model;
S38: determining a failure cause of each abnormal sequence according to the labeled template sequence; and
S39: sending the failure type and failure cause of the abnormal sequence to a user.

In step S31, monitoring data of the target device is collected in real time by the Internet of Things platform, and the monitoring data may include the first normal data and the first abnormal data. The first normal data may be monitoring data during a normal operation period of the device. The first abnormal data is monitoring data during an abnormal operation period of the device. The first normal data and the first abnormal data may be data within three months or data within one year. Formats of the first normal data and the first abnormal data may be a time series format.

Step S32 includes the following steps S321 to S326:
S321: setting a sliding window;
S322: constructing a plurality of first sub-sequences according to the first normal data and the sliding window, and calculating a first sequence mean and a first sequence standard deviation of each first sub-sequence;
S323: constructing a plurality of second sub-sequences according to the first abnormal data and the sliding window, and calculating a second sequence mean and a second sequence standard deviation of each second sub-sequence;
S324: determining a lower limit threshold of sliding mean according to a largest first sequence mean and a smallest second sequence mean;
S325: determining an upper limit threshold of sliding mean according to a smallest first sequence mean and a largest second sequence mean; and
S326: determining a standard deviation threshold according to a largest first sequence standard deviation and a smallest second sequence standard deviation.

In S321, the sliding window time W indicates that W may be equal to 10T, and T is a sampling period of monitoring data of the device. W may be equal to 2T, 3T, or the like, and is not limited herein.

In S322, the first sub-sequence X̅ᵢ=[xᵢ₊₁ xᵢ₊₂ xᵢ₊₃ . . . xᵢ₊ᵥ]; wherein

$$v = \frac{W}{T} , ;$$

The first sequence mean is

$${\overline{X}}_{i} = \frac{{x}_{i + 1} + {x}_{i + 2} + {x}_{i + 3} + … + {x}_{i + v}}{v} ;$$

The first sequence standard deviation is:

$${σ}_{i} = \sqrt{{( {x}_{i + 1} - {\overline{X}}_{i} )}^{2} + {( {x}_{i + 2} - {\overline{X}}_{i} )}^{2} + {( {x}_{i + 3} - {\overline{X}}_{i} )}^{2} + … + {( {x}_{i + v} - {\overline{X}}_{i} )}^{2}} .$$

X̅ᵢ has a maximum value of:

$${\overline{X}}_{max} = Max ( {\overline{X}}_{i} ) , i ∈ ( 1 , 2 , 3 … n - v ) ,$$

X̅ᵢ has a minimum value of X̅ₘᵢₙ as:

$${\overline{X}}_{min} = Min ( {\overline{X}}_{i} ) , i ∈ ( 1 , 2 , 3 … n - v ) ;$$

σᵢ has a maximum value of σₘₐₓ as:

$${σ}_{max} = Max ( {σ}_{i} ) , i ∈ ( 1 , 2 , 3 … n - v ) ;$$

wherein xᵢ are monitoring data points, n is a sequence length.

In S223, the second sub-sequence

$${\overline{X}}_{i}^{′} = [ {x}_{i + 1} {x}_{i + 2} {x}_{i + 3} . . {x}_{i + v} ] ;$$

wherein

$$v = \frac{W}{T} ;$$

The second sequence mean is

$${\overline{X}}_{i}^{′} = \frac{{x}_{i + 1} + {x}_{i + 2} + {x}_{i + 3} + … + {x}_{i + v}}{v} ;$$

The second sequence standard deviation is

$${σ}_{i} = \sqrt{{{( {x}_{i + 1} - {\overline{X}}_{1}^{′} )}^{2} + {( {x}_{i + 2} - {\overline{X}}_{i}^{′} )}^{2} + {( {x}_{i + 3} - {\overline{X}}_{1}^{′} )}^{2} + … + {x}_{i + v} - {\overline{X}}_{1}^{′} )}^{2}} ;$$

$${\overline{X}}_{i}^{′}$$

has a maximum value of

$${\overline{X}}_{max}^{′}$$

as:

$${\overline{X}}_{max}^{′} = Max ( {\overline{X}}_{i}^{′} ) , i ∈ ( 1 , 2 , 3 … n - v ) ;$$

$${\overline{X}}_{i}^{′}$$

has a minimum value of

$${\overline{X}}_{min}^{′}$$

as:

$${\overline{X}}_{min}^{′} = Max ( {\overline{X}}_{i}^{′} ) , i ∈ ( 1 , 2 , 3 … n - v ) ;$$

$${σ}_{i}^{′}$$

has a maximum value of

$${σ}_{max}^{′}$$

as:

$${σ}_{max}^{′} = Max ( {σ}_{i}^{′} ) , i ∈ ( 1 , 2 , 3 … n - v ) .$$

In S324, the lower limit threshold of sliding mean X̅ₜᵣₗ is:

$${\overline{X}}_{trl} = \frac{{\overline{X}}_{min}^{′} + {\overline{X}}_{max}}{2} ;$$

In S325, the lower limit threshold of sliding mean X̅ₜᵣₕ is

$${\overline{X}}_{trh} = \frac{{\overline{X}}_{max}^{′} + {\overline{X}}_{min}}{2} ;$$

In S326, the standard deviation threshold is:

$${σ}_{tr} = \frac{{σ}_{max} + {σ}_{min}^{′}}{2} .$$

In S33, training the classification model according to the first abnormal data to obtain the fault classification model may include: labeling a fault type according to the first abnormal data; training and verifying a preset original classification model according to the labeled first abnormal data; and taking the trained and verified classification model as a preset fault classification model.

Labeling the fault type according to the first abnormal data may include: determining a statistical feature of each second sub-sequence; constructing a feature vector of each second sub-sequence according to a statistical feature of each second sub-sequence; and labeling the feature vector of each second sub-sequence with a fault type.

The statistical feature of the second sub-sequence may include mean value, standard deviation, range, coefficient of variation, autocorrelation system, kurtosis, skewness, and the like of the second sub-sequence.

In step S34, determining the template sequence and labeling the template sequence may include selecting a sequence with relatively obvious features from the second sub-sequences as the template sequence, and labeling the each template sequence with a corresponding failure cause. For example, a sequence with obvious rising waveform or descending waveform feature is selected.

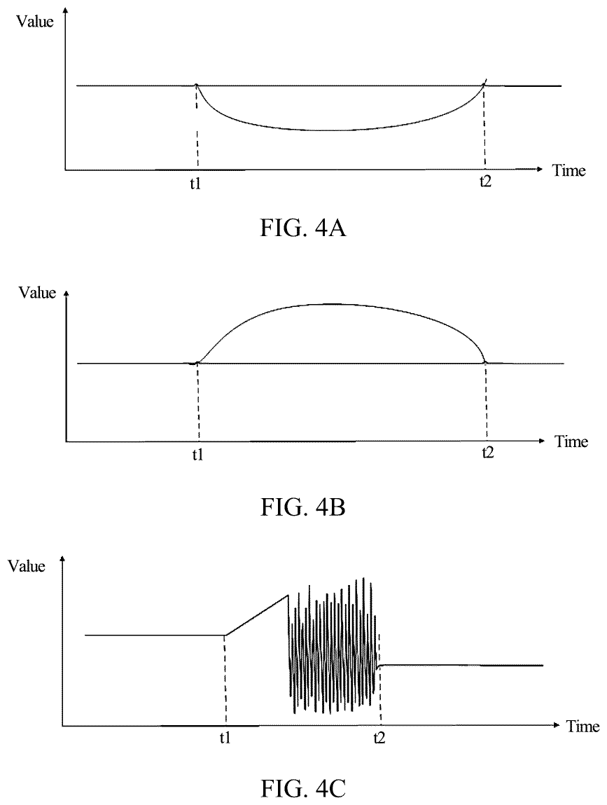

In step S36, for example, an abnormal sequence may have a descending waveform (as shown in FIG. 4A), a rising waveform (as shown in FIG. 4B), or an oscillating waveform (as shown in FIG. 4C).

Determining whether the one or more abnormal sequences exist in the data to be diagnosed according to the upper limit threshold of sliding mean, the lower limit threshold of sliding mean, and the standard deviation threshold may include:
constructing a plurality of target sub-sequences according to the data to be diagnosed and the sliding window;

On each target sub-sequence, following operations are performed:
determining whether the mean value of the target sub-sequence is less than the upper limit threshold of the sliding mean, wherein if the mean value of the target sub-sequence is less than the upper limit threshold of the sliding mean, determining whether a mean value of a next target sub-sequence adjacent to the target sub-sequence is less than the upper limit threshold of the sliding mean, and if the mean value of the next target sub-sequence adjacent to the target sub-sequence is less than the upper limit threshold of the sliding mean, continuing to determine whether a mean value of a next target sub-sequence adjacent to the above-described next target sub-sequence is less than the upper limit threshold of the sliding mean, and by analogy, until a target sub-sequence whose mean value is greater than or equal to the upper limit threshold of the sliding mean is determined; and constructing data corresponding to the target sub-sequence, data corresponding to a target sub-sequence subsequent to above-described target sub-sequence whose mean value is smaller than the upper limit threshold of the sliding mean, data between the data corresponding to the target sub-sequence and the data corresponding to the target sub-sequence subsequent to above-described target sub-sequence whose mean value is smaller than the upper limit threshold of the sliding mean into an abnormal sequence

On each target sub-sequence, following operations may also be performed:
determining whether the mean value of the target sub-sequence is greater than the lower limit threshold of the sliding mean, wherein if the mean value of the target sub-sequence is greater than the lower limit threshold of the sliding mean, determining whether a mean value of a next target sub-sequence adjacent to the target sub-sequence is greater than the lower limit threshold of the sliding mean, and if the mean value of the next target sub-sequence adjacent to the target sub-sequence is greater than the lower limit threshold of the sliding mean, continuing to determine whether a mean value of a next target sub-sequence adjacent to the above-described next target sub-sequence is greater than the lower limit threshold of the sliding mean, and by analogy, until a target sub-sequence whose mean value is less than or equal to the lower limit threshold of the sliding mean is determined; and constructing data corresponding to the target sub-sequence, data corresponding to a target sub-sequence subsequent to above-described target sub-sequence whose mean value is greater than the lower limit threshold of the sliding mean, data between the data corresponding to the target sub-sequence and the data corresponding to the target sub-sequence subsequent to above-described target sub-sequence whose mean value is greater than the lower limit threshold of the sliding mean into an abnormal sequence.

On each target sub-sequence, following operations may also be performed:
determining whether the standard deviation of the target sub-sequence is greater than the standard deviation threshold, wherein if the standard deviation of the target sub-sequence is greater than the standard deviation threshold, determining whether a standard deviation of a next target sub-sequence adjacent to the target sub-sequence is greater than the standard deviation threshold, and if the standard deviation of the next target sub-sequence adjacent to the target sub-sequence is greater than the standard deviation threshold, continuing to determine whether a standard deviation of a next target sub-sequence adjacent to the above-described next target sub-sequence is greater than the standard deviation threshold, and by analogy, until a target sub-sequence whose standard deviation is less than or equal to the standard deviation threshold is determined; and constructing data corresponding to the target sub-sequence, and data corresponding to a target sub-sequence subsequent to above-described target sub-sequence whose standard deviation is greater than the standard deviation threshold, data between the data corresponding to the target sub-sequence and the data corresponding to the target sub-sequence subsequent to above-described target sub-sequence whose standard deviation is greater than the standard deviation threshold into an abnormal sequence.

In the embodiment of the present application, with an abnormal sequence interception scheme in which the sliding mean and the sliding standard deviation are combined, whether a fault situation has occurred can be more efficiently determined.

In step S36, since a plurality of abnormal sequences may belong to a same failure occurrence time period, it is necessary to merge a plurality of sub-sections whose time is similar (that is, the time interval is within a preset range) or whose time periods intersect with each other into one large time interval. The combination method is as follows:
sorting all sub-intervals of the abnormal sequence in ascending order according to a start time.

For two adjacent sub-intervals (t1, t2), (t3, t4), if t3−t2<t_{ω} (where to is a minimum time interval for intervals with a preset value merging, and a training result in the topic is 60 seconds), then the two intervals are merged into a new interval (t1, max (t2, t4)).
comparing the merged new interval with the next interval until all sub-intervals are loop traversed.

Within the merged time interval, it is considered as the time period when a failure occurs.

In the embodiment of the present disclosure, time window merging is performed by sub-sequence merging to obtain a more accurate failure occurrence time.

In step S37, when it is determined that one or more abnormal sequences exist, a feature vector of the one or more abnormal sequence may be constructed according to the statistical features of each abnormal sequence, and a fault type corresponding to the abnormal sequence may be determined according to the feature vector and the preset fault classification model.

In an example, the preset fault classification model includes a plurality of classification models.

Determining the fault type corresponding to the abnormal sequence according to the feature vector and the preset fault classification model includes:

determining the fault type by a voting mechanism according to a classification result of each classification model.

Based on feature vectors of statistical indices, the embodiment of the present disclosure solves the problems of high dimension and heavy calculation amount in the traditional time series classification method, and greatly improves the calculation efficiency. At the same time, based on multiple base classifiers, initial classification is carried out and then a final classification result is voted, so as to obtain a better classification effect.

In step S38, determining the failure cause of each abnormal sequence according to the labeled template sequence includes following steps S381-S382:
S381, calculating a similarity between each abnormal sequence and the template sequence according to the modified DTW algorithm; and
S382, determining a fault occurrence cause corresponding to the abnormal sequence according to the similarity.

In time series, lengths of two time series that need similarity comparison may not be equal. For example, in the field of speech recognition, different people have different speech speeds. Dynamic Time Warping (DTW) is a method for measuring similarity of two time series of different lengths. DTW can calculate the similarity of two time series, especially for time series with different lengths and rhythms. DTW will automatically distort the time series (i.e., make local scaling on the time axis), so that the morphology of the two sequences is as consistent as possible, and a maximum possible similarity is obtained. Algorithm pseudocodes of DTW are described as follows:
Input: Sequence S1 and Sequence S2, with lengths m and n, respectively
Output: Distance between S1 and S2 (the smaller the distance, the more similar)

Initialize matrix D[m+1][n+1], where D[i][j] denotes a distance between the first i characters of S1 from the first j characters of S2.

$$\begin{matrix}for i = 0 , i < m , i ++ : \\ for j = 0 , j < n , j ++ : \\ dist ( i , j ) = abd ( S 1 [ i ] - S 2 [ j ] ) \\ D [ i ] [ j ] = dist ( i , j ) + min ( D [ i - 1 ] [ j ] , D [ i ] [ j - 1 ] , D [ i - 1 ] [ j - 1 ] )\end{matrix}$$

Return D[m][n] as the distance between the two sequences.

dist(i, j) is a distance function of S1[i] and S2[j]. For numerical sequences, dist(i, j) may be defined as an absolute value of a difference between S1[i] and S2[j].

The characteristic of DTW distorting (scaling) the time series, will scale the perceptual data monitoring sequence, thus violating the actual physical meaning of the sequence, changing the information in the time dimension, and affecting the rationality of the analysis results. In the present application, the DTW scheme is adjusted. When performing similarity calculation, a sequence may be translated back and forth so that the sequence to be analyzed is aligned with the template sequence as much as possible, but the sequence is not distorted, that is, points in the sequence to be analyzed and points in the template sequence must be in one-to-one correspondence, and there is no one-to-many situation. Based on the adjusted DTW scheme, sequence similarity is calculated.

Algorithm pseudo-codes of the adjusted DTW in the present application is described as follows:

```
Input: sequence S1 and sequence S2, with lengths m, n respectively;
Output: Distance of S1 and S2 (the smaller the distance, the more similar)
D;
D =∞, Δ= m − n :
if Δ= 0:
  d = 0
for i = 0, i<m, i++:
  dist (i) = abs (S1[i]−S2[i]);
  d = d + dist (i);
D = d;
else if Δ> 0:
    for j = 0, j< Δ, j++:
        d = 0;
        for i = 0, i< n, i + + :
                dist(i) = abs(S1[i + j]−S2 [i]);
                d = d + dist(i);
          D = min(d, D);
else if Δ< 0:
      for j = 0, j< abs(Δ), j++:
            d = 0;
            for i = 0, i< m, i + + :
                  dist(i) = abs(S1[i]−S2[i + j]);
                  d = d + dist(i);
              D = min(d, D);
        return D.
```

In step S381, calculating the similarity between each abnormal sequence and the preset template sequence according to the modified DTW algorithm may include:
for each abnormal sequence, when a length of the abnormal sequence is equal to a length of the template sequence, determining a similarity between the abnormal sequence and the template sequence according to a first accumulation sum; wherein the first accumulation sum is a sum of absolute values of differences between elements having same sequence numbers in the abnormal sequence and the template sequence;
when the length of the abnormal sequence is greater than the length of the template sequence, determining the similarity between the abnormal sequence and the template sequence according to an A₀-th accumulation sum to an A_{N-1}-th accumulation sum; wherein the A₀-th accumulation sum is the sum of the absolute values of the differences between the elements having the same sequence numbers in the abnormal sequence and the template sequence; the A₁-th accumulation sum is a sum of absolute values of differences between elements in the abnormal sequence and elements in the template sequence whose sequence numbers differ by 1; the A₂-th accumulation sum is a sum of absolute values of differences between elements in the abnormal sequence and elements in the template sequence whose sequence numbers differ by 2; the A_{N-1}-th accumulation sum is a sum of absolute values of differences between elements in the abnormal sequence and elements in the preset template sequence whose sequence numbers differ by N−1; N is the difference between the length of the abnormal sequence and the length of the preset template sequence, and N>0;
when the length of the abnormal sequence is smaller than the length of the preset template sequence, determining the similarity between the abnormal sequence and the template sequence according to an B₀-th accumulation sum to an B_{M-1}-th accumulation sum; wherein the B₀-th accumulation sum is the sum of the absolute values of the differences between the elements having the same sequence numbers in the abnormal sequence and the preset template sequence; the B₁-th accumulation sum is a sum of absolute values of differences between elements in the abnormal sequence and elements in the template sequence whose sequence numbers differ by −1; the B₂-th accumulation sum is a sum of absolute values of differences between elements in the abnormal sequence and elements in the template sequence whose sequence numbers differ by −2; the B_{M-1}-th accumulation sum is a sum of absolute values of differences between elements in the abnormal sequence and elements in the template sequence whose sequence numbers differ by −M+1; M is the difference between the length of the abnormal sequence and the length of the preset template sequence, and M>0;
the A₀-th accumulation sum to the A_{N-1}-th accumulation sum refers to the A₀-th accumulation sum, the A₁-th accumulation sum, the A₂-th accumulation sum . . . the A_{N-1}-th accumulation sum.
the B₀-th accumulation sum to the B_{M-1}-th accumulation sum refers to the B₀-th accumulation sum, the B₁-th accumulation sum, the B₂-th accumulation sum . . . the B_{M-1}-th accumulation sum.

Determining the similarity between the abnormal sequence and the template sequence according to the A₀-th accumulation sum to the A_{N-1}-th accumulation sum includes:
taking a smallest accumulation sum among the A₀-th accumulation sum to the A_{N-1}-th accumulation sum as the distance between the abnormal sequence and the template sequence. A smaller distance indicates a higher similarity.

Determining the similarity between the abnormal sequence and the template sequence according to the B₀-th accumulation sum to the B_{M-1}-th accumulation sum includes:
taking a smallest accumulation sum among the B₀-th accumulation sum to the B_{M-1}-th accumulation sum as the distance between the abnormal sequence and the template sequence. A smaller distance indicates a higher similarity.

In step S382, a failure cause corresponding to a template sequence having the highest similarity is selected as the cause of occurrence of the abnormal sequence failure.

In the embodiment of the present disclosure, by modifying the DTW algorithm, the sequence similarity is calculated while retaining the time attribute, and a better similarity matching effect is achieved.

In step S39, the failure type and the failure cause analyzed according to step S37 and step S38 can be pushed to a corresponding user by a message alarm function of the Internet of Things platform.

According to the method of the embodiment of the present disclosure, regardless of whether the Internet of Things device is high-power or low-power, has strong or weak communication function, detection of device failure and analysis of device failure types can be achieved, and can be centrally displayed and managed on a management interface of the Internet of Things platform, which greatly increases adaptability and ease of use of the Internet of Things platform.

For example, based on the waveform oscillation detection method of the embodiment of the present disclosure, it is possible to implement detection of image quality abnormality of screen devices such as LEDs, OLEDs, and LCDs. Or, device abnormality detection may also be performed on communication sensors, occasionally dialing medical devices, smart homes, and some miniaturized devices.

According to the method of the embodiment of the present disclosure, it is possible to perform fault diagnosis and analysis on devices in scenarios such as smart home, smart city, smart transportation, smart grid, smart building, smart agriculture, smart medical care, environmental monitoring, smart manufacturing, and smart security.

The present disclosure provides a device fault diagnosis apparatus, including a memory and a processor.

The memory is configured to store a program for device fault diagnosis.

The processor is configured to read and execute the program for device failure diagnosis, and execute the device failure diagnosis method.

The present disclosure provides a computer-readable storage medium on which computer-executable instructions are stored, wherein the computer-executable instructions are for causing the computer to perform the device fault diagnosis method described above.

The drawings of the present disclosure only involve structures involved in the present disclosure, and other structures may refer to conventional designs. The embodiments of the present disclosure and features in the embodiments may be combined to each other to obtain new embodiments if there is no conflict.

Those of ordinary skills in the art should understand that modifications or equivalent replacements may be made to the technical solutions of the present disclosure without departing from the essence and scope of the technical solutions of the present disclosure, and shall all fall within the scope of the claims of the present disclosure.

1. A device fault diagnosis method, comprising:
acquiring data to be diagnosed of a target device;
determining whether one or more abnormal sequences exist in the data to be diagnosed;
when that the one or more abnormal sequences exist is determined, constructing a feature vector of each of the one or more abnormal sequences according to a statistical feature of each abnormal sequence; and determining a fault type corresponding to the abnormal sequence according to the feature vector and a preset fault classification model.

2. The device fault diagnosis method according to claim 1, wherein determining whether the one or more abnormal sequences exist in the data to be diagnosed comprises:
constructing a plurality of target sub-sequences according to the data to be diagnosed and a preset sliding window; and
determining whether an abnormal sequence exists in the data to be diagnosed according to a mean value, a standard deviation, a preset lower limit threshold of sliding mean, a preset upper limit threshold of sliding mean and a preset standard deviation threshold of each target sub-sequence.

3. The device fault diagnosis method according to claim 2, wherein determining whether the abnormal sequence exists in the data to be diagnosed according to the mean value, the standard deviation, the preset lower limit threshold of the sliding mean, the preset upper limit threshold of the sliding mean, and the preset standard deviation threshold of each target sub-sequence comprises:
performing, on each target sub-sequence arranged in chronological order, following operations:
when it is determined that the mean value of the target sub-sequence is less than the preset upper limit threshold of the sliding mean, taking the target sub-sequence as a start abnormal sequence, and sequentially determining whether a mean value of a next target sub-sequence of the start abnormal sequence is less than the preset upper limit threshold of the sliding mean until a target sub-sequence whose mean value is greater than or equal to the preset upper limit threshold of the sliding mean is determined, and taking a last target sub-sequence whose mean value is less than the preset upper limit threshold of the sliding mean as an end abnormal sequence; and constructing data corresponding to the start abnormal sequence, data corresponding to the end abnormal sequence, and data corresponding to all target sub-sequences between the start abnormal sequence and the end abnormal sequence into the abnormal sequence.

4. The device fault diagnosis method according to claim 2, wherein determining whether the abnormal sequence exists in the data to be diagnosed according to the mean value, the standard deviation, the preset lower limit threshold of the sliding mean, the preset upper limit threshold of the sliding mean, and the preset standard deviation threshold of each target sub-sequence comprises:
performing, on each target sub-sequence arranged in chronological order, following operations:
when it is determined that the mean value of the target sub-sequence is greater than the preset lower limit threshold of the sliding mean, taking the target sub-sequence as a start abnormal sequence, and sequentially determining whether a mean value of a next target sub-sequence of the start abnormal sequence is greater than the preset lower limit threshold of the sliding mean until a target sub-sequence whose mean value is less than or equal to the preset lower limit threshold of the sliding mean is determined, and taking a last target sub-sequence whose mean value is less than the preset lower limit threshold of the sliding mean as an end abnormal sequence; and constructing data corresponding to the start abnormal sequence, data corresponding to the end abnormal sequence, and data corresponding to all target sub-sequences between the start abnormal sequence and the end abnormal sequence into the abnormal sequence.

5. The device fault diagnosis method according to claim 2, wherein determining whether the abnormal sequence exists in the data to be diagnosed according to the mean value, the standard deviation, the preset lower limit threshold of the sliding mean, the preset upper limit threshold of the sliding mean, and the preset standard deviation threshold of each target sub-sequence comprises:
performing, on each target sub-sequence arranged in chronological order, following operations:
when it is determined that the standard deviation of the target sub-sequence is greater than the preset standard deviation threshold, taking the target sub-sequence as a start abnormal sequence, and sequentially determining whether a standard deviation of a next target sub-sequence of the start abnormal sequence is greater than the preset standard deviation threshold until a target sub-sequence whose standard deviation is less than or equal to the preset standard deviation threshold is determined, and taking a last target sub-sequence whose standard deviation is greater than the preset standard deviation threshold as an end abnormal sequence, and constructing data corresponding to the start abnormal sequence, data corresponding to the end abnormal sequence, and data corresponding to all target sub-sequences between the start abnormal sequence and the end abnormal sequence into the abnormal sequence.

6. The device fault diagnosis method according to claim 3, further comprising:
merging abnormal sequences whose time intervals are within a preset range; or, merging abnormal sequences whose time periods intersect with each other.

7. The device fault diagnosis method according to claim 1, wherein
the preset fault classification model comprises a plurality of classification models; and
determining the fault type corresponding to the abnormal sequence according to the feature vector and the preset fault classification model comprises:
determining the fault type by a voting mechanism according to a classification result of each classification model.

8. The device fault diagnosis method according to claim 1, further comprising:
calculating a similarity between each abnormal sequence and a preset template sequence according to a modified Dynamic Time Warping (DTW) algorithm, and determining a fault occurrence cause corresponding to the abnormal sequence according to the similarity, wherein the preset template sequence is a sequence constructed according to abnormal data in which the fault occurrence cause is marked and a preset sliding window.

9. The device fault diagnosis method according to claim 8, wherein
calculating the similarity between each abnormal sequence and the preset template sequence according to the modified DTW algorithm comprises:
for each abnormal sequence, when a length of the abnormal sequence is equal to a length of the preset template sequence, determining a similarity between the abnormal sequence and the preset template sequence according to a first accumulation sum; wherein the first accumulation sum is a sum of absolute values of differences between elements having same sequence numbers in the abnormal sequence and the preset template sequence;
when the length of the abnormal sequence is greater than the length of the preset template sequence, determining a similarity between the abnormal sequence and the preset template sequence according to all Aₐ₋₁ accumulation sums; wherein an Aₐ₋₁ accumulation sum is a sum of absolute values of differences between elements in the abnormal sequence and elements in the preset template sequence whose sequence numbers differ by a−1; wherein 1≤a≤N, N is a difference between the length of the abnormal sequence and the length of the preset template sequence, and a and N are both positive integers; and
when the length of the abnormal sequence is smaller than the length of the preset template sequence, determining a similarity between the abnormal sequence and the preset template sequence according to all B_{b-1} accumulation sums; wherein a B_{b-1} accumulation sum is a sum of absolute values of differences between elements in the abnormal sequence and elements in the preset template sequence whose sequence numbers differ by −b+1; wherein 1≤b≤M, M is a difference between the length of the abnormal sequence and the length of the preset template sequence, and b and M are both positive integers.

10. The device fault diagnosis method according to claim 1, wherein
constructing the plurality of target sub-sequences according to the data to be diagnosed and the preset sliding window comprises:
for each datum in the data to be diagnosed, taking data in a preset sliding window with the datum as head as one target sub-sequence.

11. The device fault diagnosis method according to claim 2, comprising:
the preset upper limit threshold of the sliding mean and the preset lower limit threshold of the sliding mean and the preset standard deviation threshold are obtained as follows:
acquiring first normal data and first abnormal data of the target device;
calculating a first sequence mean and a first sequence standard deviation of each first sub-sequence, wherein the first sub-sequence is a sequence constructed according to the first normal data and the preset sliding window;
calculating a second sequence mean and a second sequence standard deviation of each second sub-sequence, wherein the second sub-sequence is a sequence constructed according to the first abnormal data and the preset sliding window;
determining the preset lower limit threshold of the sliding mean according to a largest first sequence mean and a smallest second sequence mean;
determining the preset upper limit threshold of the sliding mean according to a smallest first sequence mean and a largest second sequence mean; and
determining the preset standard deviation threshold according to a largest first sequence standard deviation and a smallest second sequence standard deviation.

12. The device fault diagnosis method according to claim 11, wherein the preset fault classification model is obtained as follows:
labeling a fault type according to the first abnormal data; and
training and verifying a preset original classification model according to the labeled first abnormal data; and
taking the trained and verified classification model as the preset fault classification model.

13. The device fault diagnosis method according to claim 12, wherein labeling a fault type according to the first abnormal data comprises:
constructing a plurality of sub-sequences according to the first abnormal data and the preset sliding window; determining a statistical feature of each sub-sequence; constructing a feature vector of each sub-sequence according to the statistical features of each sub-sequence;
and labeling the feature vector of each sub-sequence with the fault type.

14. The device fault diagnosis method according to claim 1, wherein,
the statistical feature comprises mean value, standard deviation, range, coefficient of variation, autocorrelation system, kurtosis, and skewness of the abnormal sequence.

15. A device fault diagnosis apparatus, comprising a memory and a processor, wherein:
the memory is configured to store a program for device fault diagnosis; and
the processor is configured to read and execute the program for device fault diagnosis, and perform the method according to claim 1.

16. A computer readable storage medium on which computer executable instructions are stored, wherein the computer executable instructions are configured to cause a computer to perform the method according to claim 1.
